(19) United States
(12) Patent Application Publication
(10) Pub. No.: US 2026/0153063 A1
(43) Pub. Date: Jun. 4, 2026

(54) THRUST REVERSER WITH IMPROVED RELIABILITY

(71) Applicant: SAFRAN NACELLES, GONFREVILLE-L'ORCHER (FR)

(72) Inventors: Vincent Jean-François PEYRON, MOISSY-CRAMAYEL (FR); Jihane BELLAHBIB, MOISSY-CRAMAYEL (FR)

(21) Appl. No.: 19/122,893

(22) PCT Filed: Oct. 30, 2023
(86) PCT No.: PCT/FR2023/051714

§ 371 Date: Apr. 21, 2025

(30) Foreign Application Priority Data
Oct. 31, 2022 (FR) FR2211355

(51) Int. Cl. F02K 1/76; B64D 29/00; F02K 1/70

(52) U.S. Cl. CPC F02K 1/763; B64D 29/00; F02K 1/70

(57) ABSTRACT

A thrust reverser comprises: a stationary structure and a movable structure mounted opposite an opening; an actuator for selectively moving the movable structure between a direct jet position and a thrust reversal position; wherein the thrust reverser comprises a device for measuring a distance between a first measurement point and a second measurement point which is rigidly connected to the movable structure, and one of the measurement points comprises an emitter of a wave flow and the other one of the measurement points comprises a reflector element of at least a portion of the wave flow.

### TECHNICAL FIELD OF THE INVENTION

The present invention relates to a thrust reversal system for a turbojet engine nacelle. The invention further relates to a turbojet engine nacelle integrating a thrust reversal system according to the invention.

### PRIOR ART

An aircraft is driven by a plurality of turbojet engines each housed in a nacelle which also houses a set of ancillary actuating devices related to its operation and performing various functions when the turbojet engine is running or stopped. These ancillary actuating devices include in particular a thrust reversal system, also referred to as a thrust reverser.

A nacelle typically has a tubular structure, comprising an air inlet upstream of the turbojet engine, a middle section intended to surround a fan of the turbojet engine, a downstream section integrating thrust reversal means and intended to surround the combustion chamber of the turbojet engine, and typically ends with an ejection nozzle whose outlet is located downstream of the turbojet engine.

Modern nacelles are intended to house a bypass turbojet engine capable of generating, via the rotating fan blades, a flow of hot air (primary flow) and a flow of cold air (secondary flow) which circulates outside the turbojet engine through an annular passage, also referred to as a flow path, formed between a turbojet engine fairing and an inner wall of the nacelle. The two air flows are ejected from the turbojet engine via the rear of the nacelle.

The role of a thrust reverser is, when landing an aircraft, to improve its braking capacity by redirecting at least a portion of the air ejected from the turbojet engine towards the front. In this phase, the reverser blocks at least a portion of the cold flow path and directs this flow towards the front of the nacelle, thereby generating a counter-thrust that is added to the braking of the aircraft's wheels.

A thrust reversal system conventionally comprises a cowl slidably mounted opposite an opening made in a partition delimiting at least partially a flow of a turbojet engine. The opening is intended to allow the diverted flow to pass and is, when the nacelle is operating in the direct jet configuration, sealed off by the external cowl. When operating in the reverse jet configuration, the cowl unseals the opening by means of cylinder-type linear actuators for moving the cowl. A flow diversion flap can also be activated. The cylinders extend upstream of the opening, typically between a stationary portion of the nacelle and a frame of the cowl.

The aircraft computers require information on the position and/or opening status of the cowl. This information is typically provided by an encoder placed on the cylinder. This is often a rotary encoder that measures the number of revolutions of a screw connected to the rod outlet in the case of electric gear motor actuators. Hydraulic cylinders typically incorporate an LVDT-type linear displacement sensor that measures an extended length of the rod.

Direct measurement on the actuator allows the use of sensors protected from external conditions. However, in order to obtain precise position information (millimeter precision on the position of the movable cowl), high-precision sensors and associated kinematic chain, with in particular reduced clearances, are required. Such provisions impose very high device manufacturing costs and instrumentation costs. Installing the cylinders and their sensors also requires expensive adjustment and calibration operations.

Installation and replacement/repair times and costs for sensors and cylinders are increased due to the same adjustment and calibration operations.

In the event of a break or fault in the kinematic chain linking the cylinder to the cowl, incorrect inverter status information may be generated without this being detectable.

Finally, the sensors currently used have significant impacts on costs and mass, in particular due to the measurement technologies used (LVDT) and the arrangements required to ensure the electromagnetic compatibility of the sensors with the aircraft environment.

### FIELD OF THE INVENTION

The aim of the present invention is to improve the reliability of a measurement of the position of a cowl of a thrust reversal system.

### DISCLOSURE OF THE INVENTION

For this purpose, the invention proposes a thrust reverser capable of adopting a so-called direct jet configuration and a so-called thrust reversal configuration. The thrust reverser comprises a stationary structure and a movable structure mounted opposite an opening delimited between the stationary structure and an upstream end of a movable cowl of the movable structure when the thrust reverser is in a thrust reversal configuration and an actuator for selectively moving the movable structure between the direct jet position in which the opening is sealed off and the thrust reversal position in which the opening is unsealed. According to the invention, the thrust reverser comprises a device for measuring a distance between a first measurement point and a second measurement point which is rigidly connected to the movable cowl. One of the measurement points comprises an emitter of a wave flow and the other one of the measurement points comprises a reflector element of at least a portion of the wave flow.

This results in a thrust reversal system, for which the measurement of the position and state of the movable cowl is carried out directly on the sliding cowl, procuring reliable and direct status information that is not dependent on the accuracy or state of the kinematic chain linking the actuator to the sliding cowl. Installation, maintenance and replacement of such a sensor are quick and do not require recalibration of the kinematic actuating train.

According to other particular, non-exclusive and optional embodiments of the invention:
the measuring device is a telemetric device using time of flight measurements.
the system comprises a seal that, when the movable structure is in the position in which it seals off the opening, at least partially defines, with the movable structure, a closed enclosure that extends around the first measurement point and the second measurement point;
the system comprises a device for slidably guiding the movable cowl, which device comprises at least one guide rail;
the system comprises a vane rigidly connected to the movable structure for translation therewith, and which extends into a vane recess when the movable structure is in the sealing position, the first measurement point being located in the vane recess;
the guide device comprises a slider rigidly connected to a set of vanes linked to the movable structure and which cooperates with the guide rail, and the second measurement point is located on the slider;
the measuring device is arranged so that the wave flow extends in a volume partially delimited by a web and a flange of the guide rail;
the first measurement point and the second measurement point are arranged to be contained in a protective volume defined at least in part by the movable structure, when the movable structure is in the sealing position, but also when the movable structure is in the unsealing position, as well as when the movable structure is transiting between these two positions.

The invention further applies to a nacelle comprising a thrust reverser as described above.

Other features and advantages of the invention will appear upon reading the following description of particular non-limiting embodiments of the invention.

### BRIEF DESCRIPTION OF THE FIGURES

The invention will be better understood upon reading the following description, given as a non-limiting example, and made with reference to the figures which represent:

FIG. 1 is a diagrammatic half-section view of a turbojet engine equipped with a thrust reverser according to a first embodiment of the invention in a so-called “direct jet” configuration;

FIG. 2 is a partial diagrammatic half-section view of a close-up of the thrust reverser of the turbojet engine of FIG. 1;

FIG. 3 is a partial diagrammatic half-section view of the thrust reverser according to a first embodiment of the invention in a so-called “transverse jet” thrust reversal configuration;

FIG. 4 is a diagrammatic front view of a turbojet engine according to the invention;

FIG. 5 is a diagrammatic bottom view of a turbojet engine equipped with the thrust reverser of FIG. 1;

FIG. 6 is a perspective, close-up view of a thrust reverser of the turbojet engine of FIG. 4;

FIG. 7 is a partial, perspective, close-up view similar to that of FIG. 6;

FIG. 8 is a close-up view of a distance measuring device of the thrust reverser in FIG. 1;

FIG. 9 is a diagrammatic half-section view of a turbojet engine equipped with a thrust reverser according to a second embodiment of the invention in a so-called “direct jet” configuration;

FIG. 10 is a partial diagrammatic top view of the turbojet engine of FIG. 9;

FIG. 11 is a diagrammatic half-section view of the turbojet engine of FIG. 9 in a so-called “transverse jet” thrust reversal configuration;

FIG. 12 is a partial diagrammatic top view of the turbojet engine of FIG. 11;

FIG. 13 is a diagrammatic half-section view of a turbojet engine equipped with a thrust reverser according to a third embodiment of the invention in a so-called “direct jet” configuration;

FIG. 14 is a partial diagrammatic top view of the turbojet engine of FIG. 13;

FIG. 15 is a diagrammatic half-section view of the turbojet engine of FIG. 13 in a so-called “transverse jet” thrust reversal configuration;

FIG. 16 is a partial diagrammatic top view of the turbojet engine of FIG. 15.

In these figures, identical reference numerals from one figure to another refer to identical or similar elements. Moreover, for reasons of clarity, the drawings are not to scale unless specified otherwise.

### DESCRIPTION OF THE EMBODIMENTS

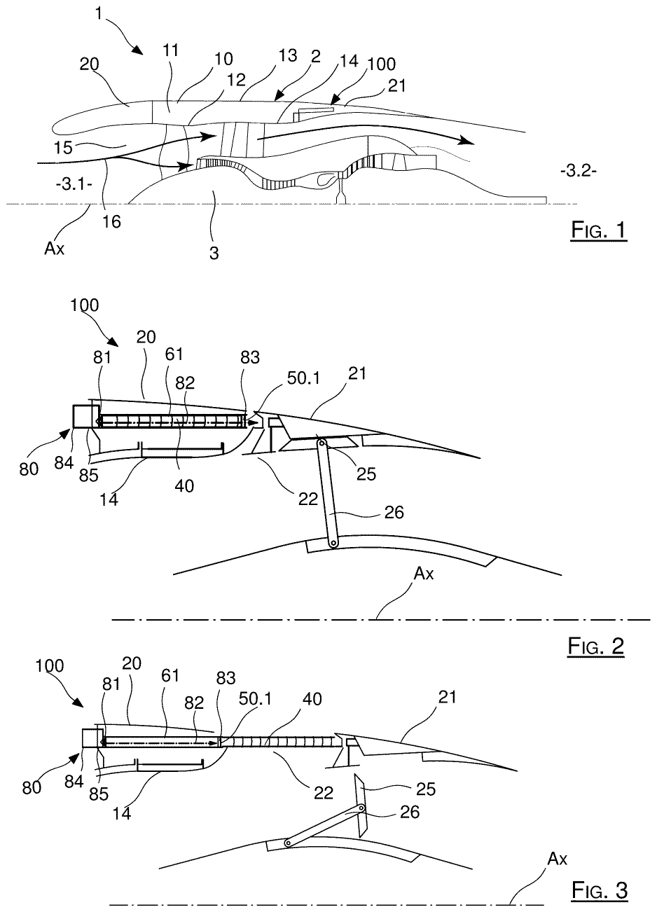

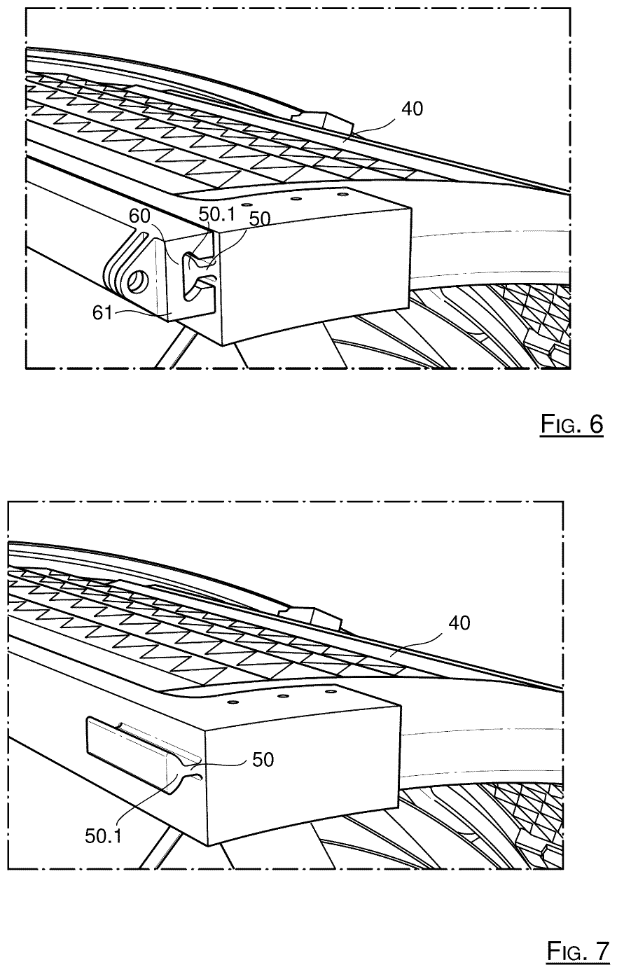

With reference to FIG. 1 to 8, a nacelle 1 comprises a structure 2 that extends around a turbojet engine 3 whose rotating elements are rotatably mounted about a longitudinal axis Ax. Air is sucked in at the upstream portion 3.1 of the turbojet engine 3 and exits through the downstream portion 3.2 of the turbojet engine 3.

In this text, the terms “upstream” and “downstream” are used with reference to the position or orientation of an element according to the direction of air flow in the turbojet engine and the terms “inner” or “internal” and “outer” or “external” are used with reference to the position or orientation relative to the longitudinal axis Ax. The structure 2 comprises an outer fairing 10 that comprises an inner recess 11, in this case delimited by an inner wall 12 and an outer wall 13. The inner wall 12 defines an outer partition 14 that delimits a flow path 15 of a flow 16 of the turbojet engine 3.

The nacelle 1 comprises a thrust reverser 100 which comprises a cylindrical, stationary, upstream cowl 20 and a movable, downstream cowl 21 mounted to slider in a direction parallel to the axis Ax opposite an annular radial opening 22 made in the partition 14.

The thrust reverser 100 further comprises four hydraulic cylinders 30, 31, 32 and 33 for selectively moving the cowl 21 between a position in which it seals off the opening 22 (FIG. 1) and a position in which it unseals the opening 22 (FIG. 2). The cylinders 30 to 33 extend parallel to the longitudinal axis Ax and are distributed at the periphery of the nacelle 1, at ninety degrees to each other. A diverter gate 25 known per se is articulated by an arm 26 and can take a position in which it deflects the flow 16 when the opening 22 is unsealed (FIG. 3).

### Movable Cascade Vanes

The thrust reverser 100 is, in this case, of the “movable cascade vane” type and comprises two sets of vanes 40 and 41 in the form of a half-cylinder and which are rigidly connected to the cowl 21 for translation therewith. Each set of vanes 40 and 41 extends into the recess 11 when the cowl 21 is in the position in which it seals off the opening 22 (FIGS. 1 and 3). The set of vanes 40 comprises a left upper slider 50 that cooperates with a dovetail-shaped left upper groove 60 in a left upper guide rail 61 rigidly connected to the stationary upstream cowl 20. The set of vanes 40 further comprises a left lower slider 51 that cooperates with a left lower groove 62, also dovetail-shaped, in a left lower guide rail 63.

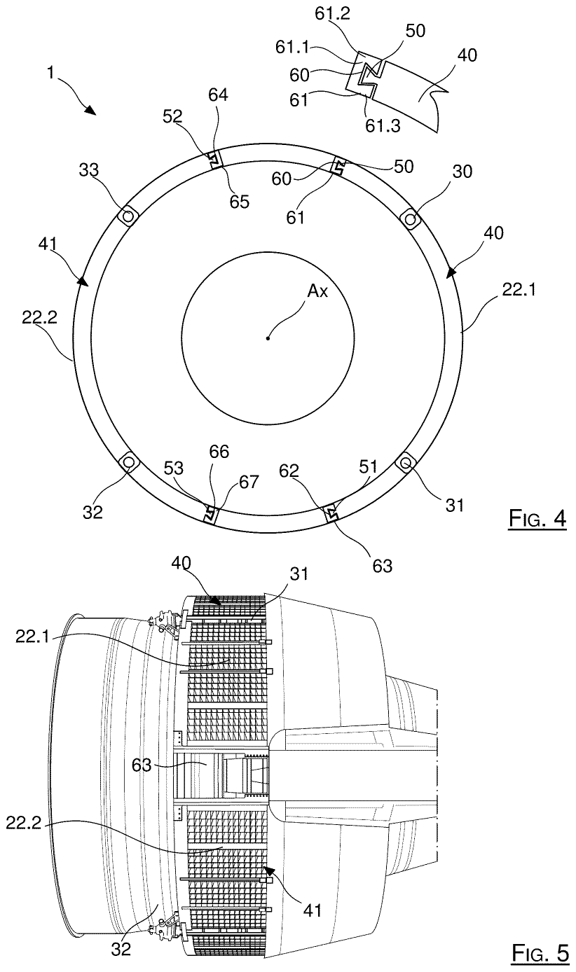

As can be seen in FIG. 4, the rail 61 has a web 61.1 from which project an upper flange 61.2 and a lower flange 61.3 to define the left upper groove 60. The set of vanes 41 is similar to the set of vanes 40. Thus, the set of vanes 41 comprises a right upper slider 52 that cooperates with a dovetail-shaped right upper groove 64 in a right upper guide rail 65 and a right lower slider 53 that cooperates with a left lower central groove 66, also dovetail-shaped, in a left lower central guide rail 67.

The rails 61, 63, 65 and 67 form, with the sliders 50 to 53, a device for guiding the cowl 21.

As can be seen in FIGS. 4 and 5, the vane assemblies 40 and 41 extend respectively opposite two sectors substantially less than one hundred and twenty-four degrees from the opening 22 when the cowl 21 is in the position in which it unseals the opening 22. Thus, the set of vanes 40 extends opposite a left sector 22.1 of the opening 22, and the set of vanes 41 extends opposite a right sector 22.2 of the opening 22.

Since all the vanes are identical, only features related to the set of vanes 40 will now be described, with these features being reproduced on the set of vanes 41.

As can be seen in FIG. 7, the thrust reverser 100 comprises a transmitter-receiver 80 provided with a diode 81 arranged to emit a laser flux 82 to a reflective target 83 positioned on an upstream end 50.1 of the slider 50. The end 50.1 extends, in this case, in a transverse plane P orthogonal to the axis Ax. As can be seen in FIGS. 2, 3 and 7, the transmitter-receiver 80 is connected to a support 84 rigidly connected to an extension 85 of the rail 61. The laser flux 82 extends in the rail 61 when the cowl 21 is moved to the position in which it unseals the opening 22, more particularly between the flanges 61.2 and 61.3. The transmitter-receiver 80 comprises a seal 86, in this case a rectangular seal of circular cross-section, arranged such that when the movable cowl 21 is in the position in which it seals off the opening 22, the seal 86 defines at least partially, with the movable cowl (in the present case, the end 50.1 of the slider 50), a closed enclosure 87 that extends around the diode 81 and around an active portion of the target 83. The transmitter-receiver 80 is connected to a processing unit 90 of the avionics system of the aircraft on which the nacelle 1 is mounted. The transmitter-receiver 80 and the reflective target 83 constitute a distance-measuring device 91.

In operation, the transmitter-receiver 80 emits a laser flux 82 towards the reflective target 83. The processing unit 90 analyses the time it takes for the laser flux 82 to travel the distance separating the transmitter-receiver 80—which constitutes a first measurement point rigidly connected to the stationary upstream cowl 20 (in this case to the rail 61)—and the reflective target 83—which constitutes a second measurement point—and to return to the transmitter-receiver 80. Based on the measured time, the processing unit 90 computes and returns to the avionics system a value for the distance separating the transmitter-receiver 80 from the reflective target 83 on the principle of telemetric measurement using time of flight measurements.

### Stationary Cascade Vanes

Elements that are identical or analogous to those described above have a reference numeral that is identical thereto in the description of a second and a third embodiment of the invention given below.

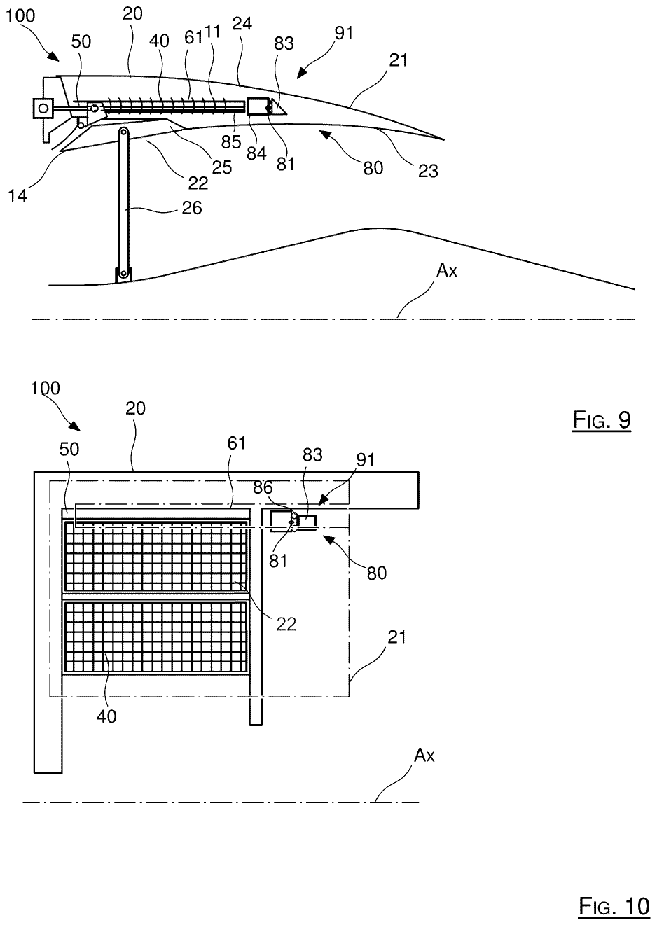

According to a second embodiment shown in FIG. 9 to 12, the thrust reverser 100 is, in this case, of the “stationary cascade vane” type and comprises two sets of vanes 40, and 41 in the form of a half-cylinder rigidly connected to the structure 2 of the nacelle 1. Each set of vanes 40 and 41 extends into the recess 11 when the cowl 21 is in the position in which it seals off the opening 22 (FIG. 9-10). The recess 11 is, according to the second embodiment, defined by an inner wall 23 and an outer wall 24 of the cowl 21. In a manner known per se, the thrust reverser 100 comprises a diverter gate 25 articulated on an arm 26.

In this second embodiment, the sliders 50 to 53 of the device for guiding the cowl 21 are rigidly connected to the cowl 21 and cooperate respectively with the rails 61, 67, 69, and 75 rigidly connected to the structure 2 of the nacelle 1.

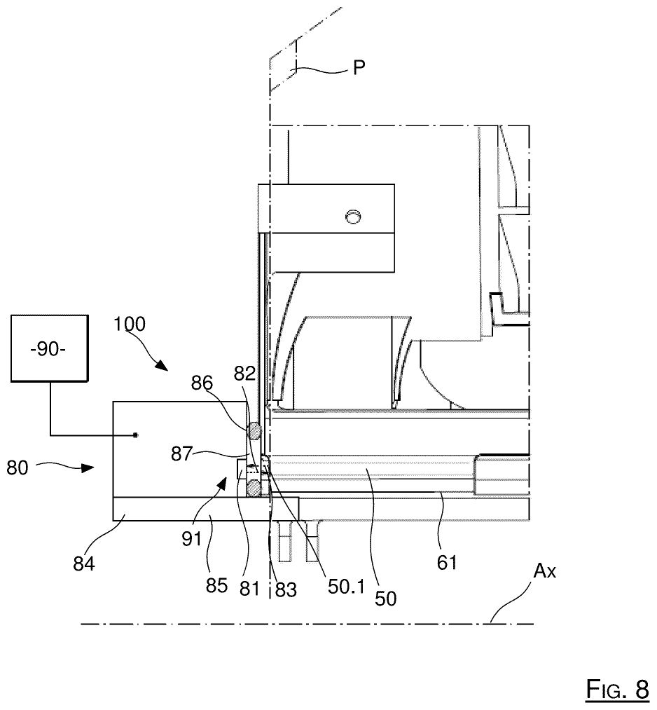

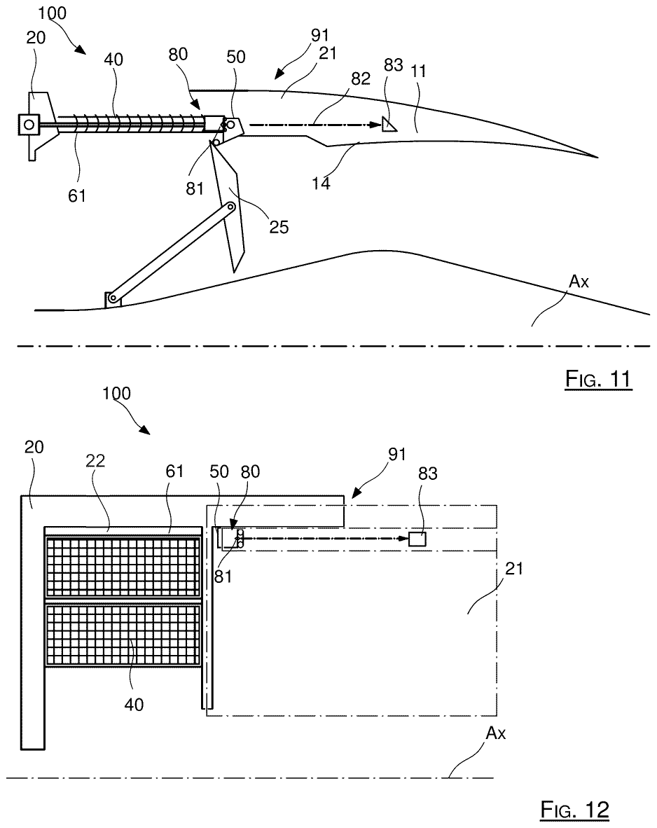

The transmitter-receiver 80 is located downstream of the set of vanes 40 and is rigidly connected to the structure of the nacelle 1. The reflective target 83 is rigidly connected to the cowl 21. As seen in FIGS. 9 and 11, the transmitter-receiver 80 extends into the inner recess 11 in the cowl 21 as well as the laser flux 82. The recess 11 thus constitutes a volume for protecting the distance-measuring device 91 against the flow 16 and the environment outside the turbojet engine 3. The seal 86 makes it possible, when the cowl 21 is in the configuration in which it seals off the opening 22 (FIG. 8), to protect the transmitter-receiver 80 and the active portion of the target 83 from the external environment (dust and moisture).

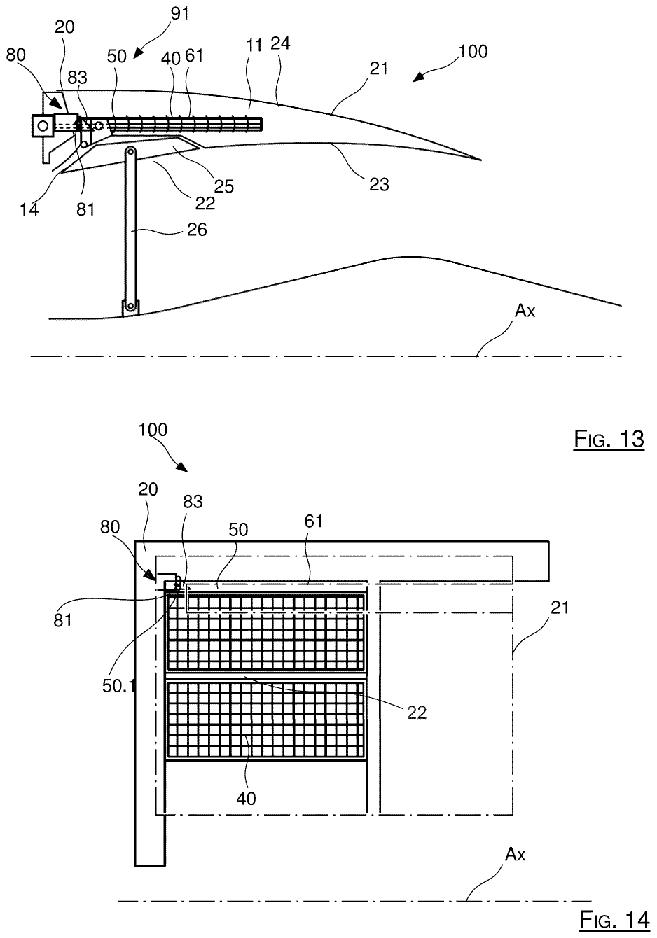

According to a third embodiment shown in FIGS. 13 and 16, the thrust reverser 100 is of the “stationary cascade vane” type in which the sliders 50 to 53 of the device for guiding the cowl 21 are rigidly connected to the cowl 21 and cooperate respectively with the rails 61, 67, 69, and 75 rigidly connected to the structure 2 of the nacelle 1.

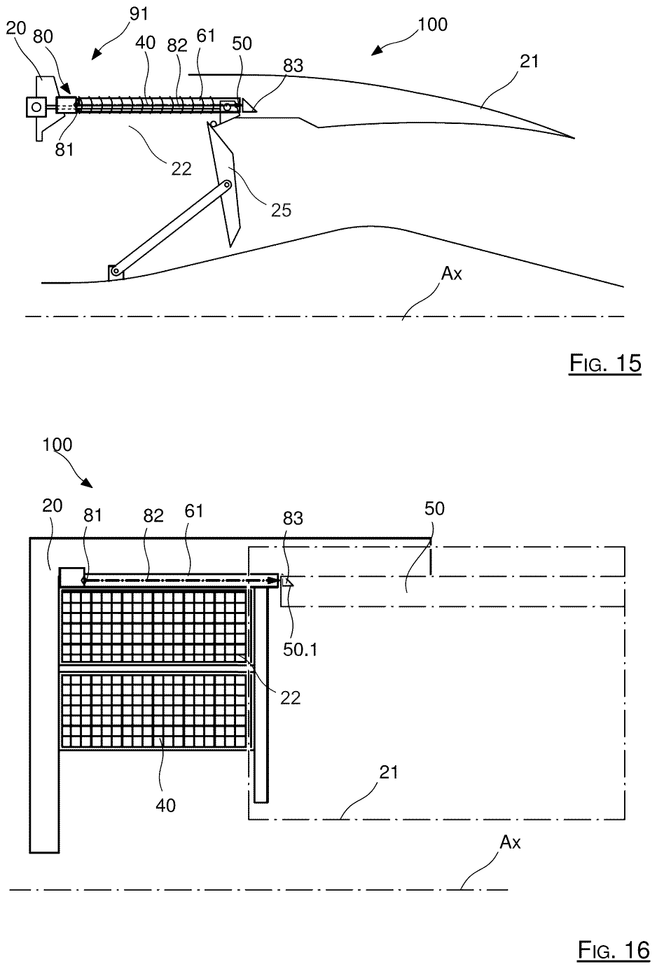

The transmitter-receiver 80 is located near the upstream end of the set of vanes 40 and is rigidly connected to the rail 61. The reflective target 83 is positioned on the upstream end 50.1 of the slider 50. As can be seen in FIGS. 15 and 16, the laser flux 82 extends in the rail 61, more particularly between the flanges 61.2 and 61.3. Again, the seal 86 makes it possible, when the cowl 21 is in the configuration in which it seals off the opening 22 (FIG. 10), to protect the transmitter-receiver 80 and the active portion of the target 83 from the external environment (dust and moisture). Thus, the second measurement point—in this case the reflective target 83—is located on the slider 50.

All of the embodiments described above comprise a measuring device 91 that is positioned near one of the guide rails 61, 63, 65 or 67. For the purposes of the present application, a guide device is located near one of the guide rails if one of its measurement points is arranged less than fifty centimeters away from said guide rail.

The operation of the distance sensor according to the second and third embodiments is identical to that of the first embodiment.

It goes without saying that the invention is not limited to the embodiments described, but encompasses any alternative embodiment that falls within the scope of the invention as defined by the claims.

In particular:
although, in this case, the thrust reverser comprises four cylinders, the invention also applies to other actuation configurations of the movable cowl such as, for example, a single actuator, or two, three or more than four actuators;
although, in this case, the thrust reverser comprises a hydraulic cylinder, the invention also applies to other types of actuators such as, for example, electric or pneumatic actuators, which may or may not be linear;
although, in this case, the groove in the guide rail is dovetail-shaped, the invention also applies to other types of groove such as, for example, grooves with a polyhedral or circular cross-section;
although, in this case, the thrust reverser comprises a laser diode, the invention applies to other types of device for measuring a distance between two points such as, for example, a cable winding drum device provided with a rotary encoder or to other types of wave flow emitter such as, for example, an emitter of an infrared ultrasound flow or a magnetic or radio wave emitter (of the radar type) or any optical sensor (camera, LIDAR);
although, in this case, the distance-measuring device carries out the distance measurement on the principle of telemetry measurement using time of flight measurements, the invention also applies to other measuring principles such as, for example, laser measurement by interferometry or measurement by triangulation;
although, in its application to a movable cascade vane system wherein the vane is rigidly connected to the cowl, and the reflective target is rigidly connected to the vane, the invention also applies to other arrangements of the second measurement point on the movable cowl such as, for example, arrangement on the inner or outer wall of the cowl;
although, in this case, the thrust reverser comprises four cylinders distributed at ninety degrees from one another, the invention also applies to other types of actuator arrangements such as, for example, two cylinders at one hundred and eighty degrees, three cylinders or more than four.

What is claimed is:

1. Thrust reverser capable of adopting a so-called direct jet configuration and a so-called thrust reversal configuration, the thrust reverser comprising:
a stationary structure and a movable structure mounted opposite an opening delimited between the stationary structure and an upstream end of a movable cowl of the movable structure when the thrust reverser is in a thrust reversal configuration;
an actuator for selectively moving the movable structure between the direct jet position in which the opening is sealed off and the thrust reversal position in which the opening is unsealed;
wherein,
the thrust reverser comprises a device for measuring a distance between a first measurement point and a second measurement point which is rigidly connected to the movable structure, and
one of the measurement points comprises an emitter of a wave flow and the other one of the measurement points comprises a reflector element of at least a portion of the wave flow,
the thrust reverser comprising a seal which, when the movable structure is in the position in which it seals off the opening, defines at least partially, with the movable structure, a closed enclosure that extends around the first measurement point and the second measurement point.

2. The thrust reverser according to claim 1, wherein the measuring device is a telemetric device using time of flight measurements.

3. The thrust reverser according to claim 1, comprising a device for slidably guiding the movable structure, the guide device comprising at least one guide rail.

4. The thrust reverser according to claim 3, wherein the guide device comprises a slider rigidly connected to a set of vanes linked to the movable structure and which cooperates with the guide rail, the second measurement point being located on the slider.

5. The thrust reverser according to claim 1, comprising a vane rigidly connected to the movable structure for translation therewith, and which extends into a vane recess when the movable structure is in the sealing position, the first measurement point being located in the vane recess.

6. The thrust reverser according to claim 3, wherein the measuring device is arranged so that the wave flow extends in a volume partially delimited by a web and a flange of the guide rail.

7. The thrust reverser according to claim 1, wherein the first measurement point and the second measurement point are arranged to be contained in a protective volume defined at least in part by the movable structure, when the movable structure is in the sealing position, but also when the movable structure is in the unsealing position, as well as when the movable structure is transiting between these two positions.

8. A nacelle comprising the thrust reverser according to claim 1.
